(19) United States
(12) Patent Application Publication
(10) Pub. No.: US 2016/0035285 A1
(43) Pub. Date: Feb. 4, 2016

(54) METHOD AND APPARATUS FOR CONTROLLING BRIGHTNESS OF AN IMAGE DISPLAY

(71) Applicant: Samsung Electronics Co., Ltd., Gyeonggi-do (KR)

(72) Inventor: Han-sub JUNG, Gyeonggi-do (KR)

(73) Assignee: Samsung Electronics Co., Ltd.

(21) Appl. No.: 14/591,407

(22) Filed: Jan. 7, 2015

(30) Foreign Application Priority Data
Aug. 1, 2014 (KR) 10-2014-0098920

(51) Int. Cl. G09G 3/34; G09G 3/32; G09G 3/36

(52) U.S. Cl. CPC G09G 3/3406; G09G 3/3607; G09G 3/3208; G09G 2360/144; G09G 2320/029; G09G 2320/103; G09G 2320/0653; G09G 2320/0633; G09G 2320/0666

(57) ABSTRACT

An image display apparatus and a method thereof are provided. The image display apparatus includes a display configured to display an image; a sensor configured to detect a condition of a surrounding environment of the image display apparatus; and a brightness adjuster configured to change, in response to detection of a change in the condition of the surrounding environment of the image display apparatus, a screen brightness of the display based on the detected changed condition of the surrounding environment.

### PRIORITY

This application claims priority under 35 U.S.C. §119(a) to a Korean Patent Application No. 10-2014-0098920, which was filed in the Korean Intellectual Property Office on Aug. 1, 2014, the entire content of which is incorporated herein by reference.

### BACKGROUND

1. Field of the Invention

The present invention relates generally to a method and apparatus for displaying an image, and more particularly, to a method and an image display apparatus that control screen brightness in consideration of a characteristic of an image displayed on a screen.

2. Description of the Related Art

Terminal devices, such as smartphones, generally include logic for automatically adjusting their screen brightness according to changes in a surrounding environment. For example, when illumination is changed as the user of the terminal device goes indoors or outdoors, a terminal device may change its screen brightness in order to maintain visibility. As another example, when a temperature of the terminal device increases, the terminal device may reduce the screen brightness to reduce the temperature. As yet another example, when a battery of the terminal is running low, the terminal device may reduce the screen brightness to reduce power consumption of the terminal.

However, such an abrupt change in the screen brightness makes the user feel uncomfortable, and the user's ability to concentrate on content of the screen diminishes while viewing the screen during such a change. In particular, in terminal devices that use an Organic Light Emitting Diode (OLED)-based display, it is difficult to perform minute adjustments to screen brightness, and thus the user may feel even more uncomfortable than when similar adjustments are performed in a device with a Liquid Crystal Display (LCD). More specifically, since an OLED display has a higher resolution than that of a corresponding LCD, and the user is more sensitive to changes in the screen brightness of an OLED display. Therefore, the user feels more uncomfortable.

### SUMMARY OF THE INVENTION

An aspect of certain embodiments is to overcome the above-described disadvantages and/or other disadvantages not described above. However, it is understood that embodiments of the present invention are not required to overcome any or all of the above-described disadvantages and problems.

An aspect of certain embodiments of the present invention is to provide an image display apparatus and method that can control screen brightness in consideration of a characteristic of an image displayed on a screen, when a surrounding environment condition of the image display apparatus, such as, ambient light, for example, is changed, in order to prevent a user from feeling uncomfortable due to the changes in the screen brightness.

According to an aspect of the present invention, an image display apparatus is provided. The image display apparatus includes a display configured to display an image; a sensor configured to detect a condition of a surrounding environment of the image display apparatus; and a brightness adjuster configured to change, in response to detection of a change in the condition of the surrounding environment of the image display apparatus, a screen brightness of the display based on the detected changed condition of the surrounding environment.

According to another aspect of the present invention, a method of controlling an image display apparatus is provided. The method includes displaying an image on a display screen of the image display apparatus; detecting a condition of a surrounding environment of the image display apparatus; and changing, in response to detection of a change in the condition of the surrounding environment of the image display apparatus, a screen brightness of the image based on the detected changed condition of the surrounding environment.

### BRIEF DESCRIPTION OF THE DRAWINGS

The above and/or other aspects, features, and advantages of the present invention will be more apparent from the following detailed description in conjunction with the accompanying drawings, in which:

FIG. 1 is a block diagram illustrating a configuration of an image display apparatus according to an embodiment of the present invention;

FIG. 2 is a block diagram illustrating a configuration of an image display apparatus according to another embodiment of the present invention;

FIG. 3 is a block diagram illustrating a configuration of an image display apparatus according to yet another embodiment of the present invention;

FIG. 4 is a diagram illustrating a method for setting screen brightness of an image display apparatus shown in any of FIGS. 1 to 3 according to an embodiment of the present invention;

FIG. 5 is a diagram illustrating a result of a comparison between a screen display state of an image display apparatus according to an embodiment of the present invention and a screen display state of a related-art apparatus;

FIG. 6 is a flowchart illustrating a driving process of an image display apparatus according to an embodiment of the present invention corresponding to FIG. 1; and

FIG. 7 is a flowchart illustrating a driving process of an image display apparatus according to the embodiment of the present invention corresponding to FIG. 2.

### DETAILED DESCRIPTION OF EMBODIMENTS OF THE PRESENT INVENTION

Various embodiments of the present invention will now be described in detail with reference to the accompanying drawings. In the following description, specific details such as detailed configurations and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In the following description, same or similar reference numerals may be used for the same or similar elements depicted in different drawings.

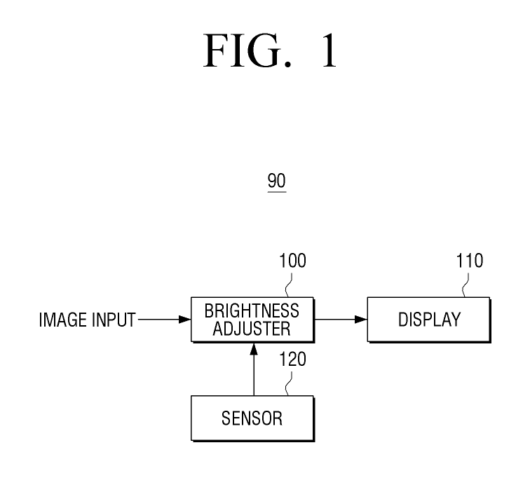

FIG. 1 is a block diagram illustrating a configuration of an image display apparatus according to an embodiment of the present invention.

Referring to FIG. 1, an image display apparatus 90 according to an embodiment of the present invention can be any of various kinds of portable apparatuses, such as a smartphone, a tablet Personal Computer (PC), a laptop computer, a Motion Picture Experts Group (MPEG) Audio Layer 3 (MP3) player, or a Portable Digital Assistant (PDA). The display apparatus 90 includes a brightness adjuster 100, a display 110, and a sensor 120.

Herein, all, or a portion of some elements, like the sensor 120 may be integrated into other elements like the brightness adjuster 100 or the display 110 in accordance with embodiments of the present invention.

When a screen of the display 110 is turned on, in response to this change, the brightness adjuster 100 displays an image with an optimum screen brightness determined according to a condition of a surrounding environment of the image display apparatus 90. For example, the optimum screen brightness may be determined according to ambient light. Thereafter, in response to the surrounding environment condition being changed, the brightness adjuster 100 changes the current screen brightness in consideration of the changed surrounding environment condition and a characteristic of an input image.

Herein, a situation in which the screen turns on may include a case in which the image display apparatus 90 is turned on or a case in which the screen was temporarily turned off to save power and is subsequently turned on again. In the latter case, the screen may be turned on in response to a detected touch on the image display apparatus 90. According to an embodiment of the present invention, an optimum screen brightness refers to values of a predetermined screen brightness matched with certain illumination values, and indicates the best condition under which the user can see the image displayed on the screen of the image display apparatus 90 at a certain level of illumination. Accordingly, the optimum screen brightness refers to a best condition of visibility. The optimum screen brightness may be determined based on a user's experience or various experiments. According to certain embodiments of the present invention, the optimum screen brightness is determined through experiments, but, if the user frequently uses specific screen brightness at a certain level of illumination, the optimum screen brightness may be determined based on such a user's experience.

The brightness adjuster 100 determines whether to change the screen brightness in response to changes in the conditions of the surrounding environment. To determine whether conditions of the surrounding environment condition have changed, the brightness adjuster 100 may compare an illumination value provided by an illumination sensor (e.g., an illumination sensor included in the sensor 120) at a current location and an illumination value at a previous location, and, in when the difference between the illumination values is outside of a predetermined range, the brightness adjuster 100 may change the screen brightness. Alternatively, when a difference between an optimum screen brightness corresponding to an illumination value received through the illumination sensor at a current location and an optimum screen brightness corresponding to an illumination value at a previous location is outside of a predetermined deviation, in response, the brightness adjuster 100 may change the screen brightness. Furthermore, when an illumination value exceeds a predetermined threshold value, the brightness adjuster 100 may change the screen brightness regardless of the illumination value at the previous location. Furthermore, the brightness adjuster 100 may determine an illumination value and/or change the screen brightness at predetermined time intervals.

In response to a determination to change the screen brightness, the brightness adjuster 100 changes the screen brightness in consideration of a characteristic of an image displayed on the current screen. More specifically, the brightness adjuster 100 analyzes a characteristic of an image input (or to be input) from an external source or an internal memory. By analyzing the characteristic of the image, the brightness adjuster 100 may determine whether the image is a white tone image or a black tone image (or degree of shade of the image). Herein, determining whether the image is a white tone image or a black tone image refers to a determining whether colors of the entire image include bright colors or dark colors. More specifically, the brightness adjuster 100 analyzes grayscale values of pixels of the image (e.g., analyzes grayscale values of each of the pixels of the image, on a scale including 256 grayscale values, and, when an average of the grayscale values of the pixels is greater than a median grayscale value, in response, the brightness adjuster 100 determines that the image is a white tone image. Herein, the median grayscale value refers to a grayscale value corresponding to 128 on a scale including 256 grayscale values. Accordingly, when the average of the grayscale values is greater than the grayscale value corresponding to 128, in response, the image the brightness adjuster 100 determines that the image is a white tone image. Herein, the grayscale indicates how bright/dark a color is on a scale of 256 grayscale levels. The grayscale value refers to a value corresponding to a specific one of the 256 grayscale levels.

During such a determination process, the brightness adjuster 100 may set threshold values for determining whether the image is a white tone image or a black tone image and may change the screen brightness in response to a determination that the white tone image has an average grayscale value less than a threshold value, or when the black tone image has an average grayscale value greater than the threshold value. More specifically, according to an embodiment of the present invention, the brightness adjuster 100 may change the screen brightness to a value lower than a predetermined optimum screen brightness in consideration of characteristics of the image in addition to the changed surrounding environment condition, rather than changing the screen brightness only in consideration of the changed conditions of the surrounding environment. For example, the brightness adjuster 100 may change the screen brightness to a value lower than the predetermined optimum screen brightness within a lower limit of visibility. Herein the lower limit of visibility is a minimum value of the screen brightness being determinable for any illumination value. The optimum screen brightness may vary whenever the conditions of the surrounding environment condition changes. In response to a determination that the illumination value of the surrounding environment is outside of the visibility lower limit, the brightness adjuster 100 may change the screen brightness to an optimum screen brightness matched with the lower limit, regardless of the characteristics of the image.

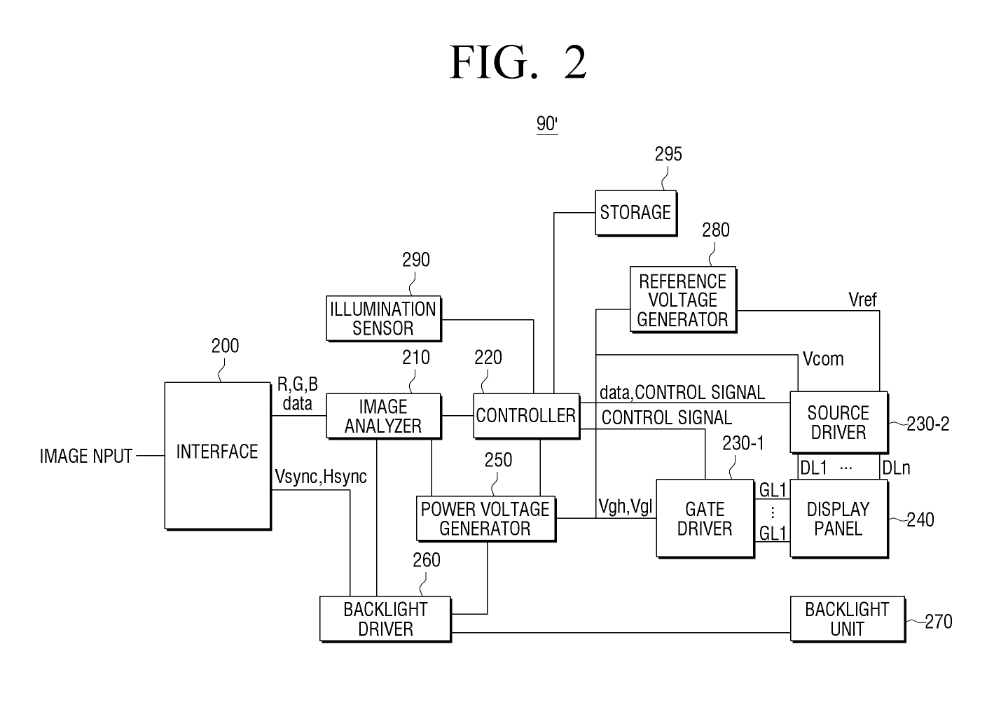

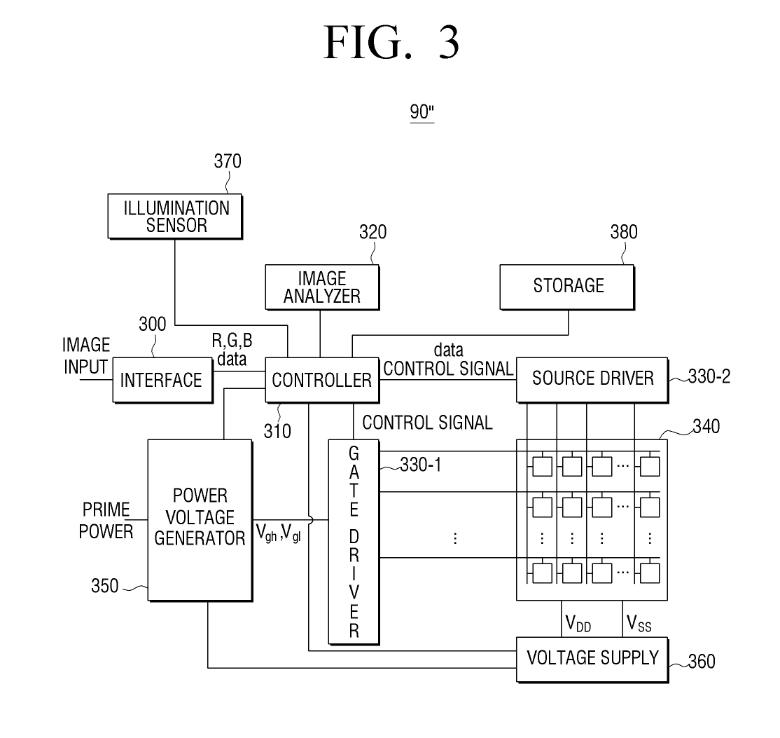

To perform the above-described operations, the brightness adjuster 100 may include different elements that vary according to a display type of the image display apparatus 90. More specifically, an LCD image display apparatus and an OLED image display apparatus are described in more detail with reference to FIGS. 2 and 3. The OLED image display apparatus is different from the LCD image display apparatus, in that the OLED image display apparatus emits light by itself. Accordingly, there may be a difference in mechanisms \for controlling screen brightness of each of these respective devices according to embodiments of the present invention.

Referring back to FIG. 1, the display 110 displays an image on the screen. When initially displaying the image, the display 110 displays the image with a predetermined optimum screen brightness. In response to a determination that a surrounding environment conditions of the image display apparatus 90 is changed while the screen is turned on, the display 110 displays the image with a screen brightness based on the changed surrounding environment conditions and characteristics of the image. The changed screen brightness may be set lower than a screen brightness changed in consideration of only the changed surrounding environment conditions (i.e., without also considering characteristics of the image itself). Accordingly, the user may not feel uncomfortable due to the change of the screen brightness.

Herein, the display 110 generally refers to a display panel on which an image is displayed, for example, a display panel including an LCD or an OLED. However, in when using an LCD, it is possible to mount or form a peripheral circuit (e.g., a driver such as a source driver or a gate driver) on a glass substrate forming a display panel. Therefore, according to some embodiments of the present invention, the display 110 may further include a peripheral circuit.

The display 110 may further include a touch panel (not shown) to detect a screen touch. Accordingly, in response to a user's touch on the screen, the image display apparatus 90 may turn on the screen of the display 110 that was temporarily turned off for the sake of power saving. The image display apparatus 90 may include a detection sensor to detect whether the user grasps the image display apparatus 90. In this case, the image display apparatus 90 may turn on the screen of the display 110, which was temporarily turned off, in response to a touch being detected by the touch sensor.

The sensor 120 may include a detection sensor (not shown) to detect surrounding environment conditions of the image display apparatus 90, such as ambient light, for example. A detection signal that is detected by the detection sensor (i.e., a brightness value) is provided to the brightness adjuster 100. In the present example, ambient light is used as a surrounding environment condition. However, a driving state of the image display apparatus 90 (e.g., a state of a video or an application) may be used as surrounding environment conditions. Therefore, operations of the sensor 120 are not limited to the detection of ambient light.

FIG. 2 is a block diagram illustrating a configuration of an image display apparatus according to another embodiment of the present invention.

As shown in FIG. 2, an image display apparatus 90′ according to an embodiment of the present invention includes an interface 200, an image analyzer 210, a controller 220, gate drivers 230_1, source drivers 230_2, a display panel 240, a power voltage generator 250, a backlight driver 260, a backlight unit 270, a reference voltage generator 280, an illumination sensor 290, and a storage 295.

According to alternative embodiments of the present invention, some elements of FIG. 2, such as the interface 200 and the image analyzer 210, for example, may be omitted and/or configured as separate elements. Some elements, such as the image analyzer 210, may be integrated into other elements, such as the controller 220, for example, in accordance with embodiments of the present invention.

The interface 200 is an image board (e.g., a graphic card) and converts image data input from an external source to have a resolution suitable for the image display apparatus 90′ and outputs the converted image data. The image data may include video data having 8-bitRed, Green, Blue (RGB) color components, and the interface 200 may generate control signals such as a digital clock signal (DCLK) and vertical and horizontal synchronization signals (Vsync and Hsync) suitable for the resolution of the image display apparatus 90′. The interface 200 provides the image data to the image analyzer 210 and provides the vertical/horizontal sync signals to the backlight driver 260 such that the backlight unit 270 operates in synchronization with a realized image displayed on the display panel 240.

For example, when receiving a broadcast signal, the interface 200 tunes to a broadcast of a specific channel, demodulates image data input through the tuned channel, separates the demodulated image data into video, audio, and additional information, decodes the video, audio, and additional information, and converts the decoded video to a resolution suitable for the image display apparatus 90′. Accordingly, the interface 200 includes a High-Definition Multimedia Interface (HDMI) signal receiver as a signal receiver or a tuner, and may further include a demodulator, a data divider, a decoder, etc.

The image analyzer 210 analyzes the input image data at predetermined time intervals, and provides a result of the analyzing to the backlight driver 260. The image analyzer 210 may analyze the image data only in response to a request of the controller 220, receive image data stored in the storage 295 under control of the controller 220, and analyze the image data. Accordingly, there are limits to situations in which the image analyzer 210 analyzes the image in accordance with embodiments of the present invention.

For example, in response to a determination that the illumination detected by the illumination sensor 290 is changed, the image analyzer 210 may operate under control of the controller 220. Accordingly, in response to a request of the controller 220, the image analyzer 210 determines a characteristic of the image by analyzing a still image displayed on the current screen (or a plurality of still images during a predetermined time when a video is displayed). Characteristics of the image indicate whether the image is a black tone image or a white tone image as described above. More specifically, the image analyzer 210 further determines whether an average grayscale value of the black tone image is greater than a threshold value or an average grayscale value of the white tone image is less than a threshold value. A result of the determination is provided to the backlight driver 260.

The controller 220 provides video data provided via the image analyzer 210 to the source driver 230_2, and controls video data output at the source driver 230_2 using a control signal, such that an image is realized on the display panel 240. The controller 220 also controls the gate driver 230_1 to provide a gate on/off voltage provided by the power voltage generator 250 to the display panel 240 in horizontal lines. For example, in response to a determination that a gate voltage being applied to a gate line 1 (GL1), the controller 220 controls the source driver 230_2 to apply video data corresponding to a first horizontal line. The controller 220 also applies video data corresponding to a second horizontal line from the source driver 230_2 to the display panel 240, by turning on a gate line 2 (GL2) and simultaneously turning off the first gate line. In this manner, the controller 220 controls display of the image on the entire screen of the display panel 240.

According to an embodiment of the present invention, the controller 220 receives the illumination value provided by the illumination sensor 290, transmits the received illumination value to the storage 295, and receives a brightness value of an optimum screen brightness matched with the corresponding illumination value. This operation may be performed in response to a determination that the screen of the display panel 240 is initially turned on. The image display apparatus 90′ displays the image with predetermined screen brightness matched with a certain illumination value (i.e., optimum screen brightness). Thereafter, in response to the change of the surrounding environment conditions of the image display apparatus 90′, the controller 220 may receive a changed illumination value provided by the illumination sensor 290. For example, in response to a determination that a difference between the current illumination value and the previous illumination value is outside of a predetermined range, the controller 220 requests the image analyzer 210 to analyze the image, receives a result of the analysis, provides the analysis result to the storage 295 along with the changed illumination value, and receives a screen brightness value matched with a condition corresponding to the analysis result. In addition, the controller 220 may provide the brightness value to the backlight driver 260 via the image analyzer 210, or directly provide the brightness value to the backlight driver 260. As described above, the change in the surrounding environment condition may be determined by using a deviation between brightness values of optimum screen brightness matched with corresponding illumination values, in addition to the difference between the illumination values.

The gate driver 230_1 receives gate on/off voltages (Vgh/Vgl) provided by the power voltage generator 250, and applies a corresponding voltage to the display panel 240 under a control of the controller 220. The gate on voltage (Vgh) is provided to gate lines spanning from the gate line 1 (GL1) to the gate line N (GLn) serially, in response to a unit frame image being realized on the display panel 240.

The source driver 230_2 converts serial video data provided by the controller 220 into parallel video data, converts digital data into analogue data, and provides video data corresponding to a single horizontal line to the display panel 240 simultaneously. In addition, the source driver 230_2 receives a common voltage (Vcom) generated by the power voltage generator 250 and a reference voltage (Vref) (or a gamma voltage) provided by the reference voltage generator 280. The common voltage (Vcom) is provided to a common electrode of the display panel 240 and the reference voltage (Vref) is provided to a D/A converter in the source driver 230_2 to be used to represent grayscale of a color image. More specifically, the video data provided by the controller 220 is provided to the D/A converter, and digital information of the video data provided to the D/A converter is converted into an analogue voltage that represents grayscale of a color and is provided to the display panel 240.

The display panel 240 may include (not shown) a first substrate and a second substrate, and a liquid crystal layer interposed therebetween. The first substrate includes a plurality of gate lines (GL1 to GLn) and a plurality of data lines (DL1 to DLn) that intersect with each other to define a pixel area, and a pixel electrode is formed in the pixel area formed by the intersecting lines. A Thin Film Transistor (TFT) is formed at a certain area of the pixel area (e.g., at a corner of the pixel area). In response to a determination that the TFT is turned on, the liquid crystal is twisted according to a difference between a voltage applied to the pixel electrode of the first substrate and a voltage applied to a common electrode of the second substrate, thereby allowing light of the backlight 270 to pass through. The display panel 240 generally performs opposite operations according to whether a type of the display pane 240 is normally white or normally black. More specifically, in the normal white mode, a white screen is displayed when a voltage is not applied to the display panel 240. Meanwhile, in the normal black mode, a black screen is displayed when a voltage is not applied to the display panel 240.

The power voltage generator 250 receives a prime voltage (i.e., an alternating current voltage of 110V or 220V) from an external source, generates DC voltages of various levels, and outputs the DC voltages. For example, the power voltage generator 250 generate and provides voltage of various levels (e.g., a DC 15V voltage as a gate on voltage (Vgh) for the gate driver 230_1, a DC 24V voltage for the backlight driver 260, and a DC 12V voltage for the controller 220). Furthermore, the power voltage generator 250 generates and provides a driving voltage for the image analyzer 210.

The backlight driver 260 converts the voltage provided by the power voltage generator 250 and provides the converted voltage to the backlight unit 270. In addition, the backlight driver 260 simultaneously turns on R, G, and B LEDs constituting the backlight unit 270 to provide white light. The backlight driver 260 may change a state of the white light according to a surrounding environment condition of the image display apparatus 90′ (i.e., an illumination value detected by the illumination sensor 290). A change in the state of the white light, for example, an amount of white light, may change the screen brightness of the display panel 240.

In addition, in changing the state of the white light, the backlight driver 260 may receive a result of analyzing characteristics of an image from the image analyzer 210, in response to a determination that there are changes to the surrounding environment while the screen of the display panel 240 is turned on. The backlight driver 260 may directly receive the result of the analysis from the controller 220. The backlight driver 250 changes the state of the white light by considering the result of the analyzing of the image characteristic in addition to the changed state of the surrounding environment.

The illumination sensor 290 includes a detection sensor. For example, the detection sensor may be a light sensor and generate a current in proportion to an intensity of received light and may determine an illumination value based on a voltage generated by the current. The determined illumination value is provided to the controller 220.

The storage 295 stores information for forming an optimum screen brightness matched with each illumination value in the form of a LookUp Table (LUT). In addition, the storage 295 stores information determined in consideration of illumination values and characteristics of an image altogether. Accordingly, when an illumination value is provided by the controller 220, the storage 295 outputs a value corresponding to an optimum screen brightness matched with the corresponding illumination value, and, in based on resulting values regarding an illumination value and an image characteristic, the storage 295 outputs a screen brightness value corresponding to these resulting values.

FIG. 3 is a block diagram illustrating a configuration of an image display apparatus according to another embodiment of the present invention.

Referring to FIG. 3, an image display apparatus 90″ according to an embodiment of the present invention includes an interface 300, a controller 310, an image analyzer 320, a gate driver 330_1, a source driver 330_2, a display panel 340, a power voltage generator 350, a voltage supply 360, an illumination sensor 370, and a storage 380.

In a manner similar to that described above regarding FIG. 2, according to alternative embodiments of the present invention, some elements of FIG. 3 may be omitted and/or configured as separate elements. Some elements may be integrated into other elements in accordance with embodiments of the present invention.

Referring to FIG. 3, the image display apparatus 90″ of FIG. 3 according to the third embodiment is similar to the image display apparatus 90′ of FIG. 2. However, in the image display apparatus 90″, the image analyzer 320 is only connected to the controller 310, instead of being located between the interface 300 and the controller 310 like the image analyzer 210 of FIG. 2. However, according to an alternative embodiment of the present invention, the image display apparatus 90″ may have a connecting configuration similar to that shown in FIG. 2. However, the image display apparatus 90″ of FIG. 3 is a variation of the image display apparatus 90′ of FIG. 2 that analyzes an image only in response to a request of the controller 310 and provides a result of the analysis.

Since the display panel 340 has its own light emitting element, such as an OLED, the controller 310 changes grayscale voltages of R, G, and B light emitting elements to form an optimum screen brightness according to an illumination value detected by the illumination sensor 370, when the screen (not shown) is turned on. Herein, the term “grayscale voltage” refers to an analogue voltage representing a grayscale of a color. Different grayscale voltages may be applied to the R, G, and B light emitting elements regarding a first illumination value and a second illumination value, even if the R, G, and B light emitting elements correspond to the same pixel. For example, when the R, G, and B light emitting elements output a white light corresponding to a grayscale value of 250 from among 256 grayscale values regarding the first illumination value, the R, G, and B light emitting diodes may output white light corresponding to a grayscale value of 255 from among 256 grayscale values regarding the second illumination value. By changing the grayscale voltage in this way, an amount of current flowing into the light emitting elements is changed, and accordingly, each light emitting element emits light. The amount of emitted light may be increased by increasing the voltage for the same light emitting element or by increasing an amount of current by extending an amount of time the voltage is applied. In other words, the light emitting element may be controlled by using a constant voltage or a constant current.

In response to changes to conditions of the surrounding environment of the image display apparatus 90″ (i.e., changes to illumination), the controller 310 determines a grayscale voltage for the R, G, and B light emitting elements in consideration of the changed illumination value along with characteristics of an image. For example, when the changed illumination corresponds to the second illumination value as in the above example, the grayscale voltage may be changed in consideration of the characteristics of the image, such that the R, G, and B light emitting elements have a grayscale value of 253, which is lower than the grayscale value of 255 from among the 256 grayscale values. Herein the grayscale value of 255 refers to a value determined by only the changed illumination value.

The storage 380 stores screen brightness values corresponding to respective illumination values in a manner similar to the storage 295 of FIG. 2, and further stores screen brightness values obtained by additionally considering image characteristics. This information may be stored in the form of an LUT. The brightness values stored in the storage 380 of FIG. 3 may be stored in the form of grayscale voltages for the R, G, and B light emitting elements, which distinguishes the storage 380 of FIG. 3 from the storage 295 of FIG. 2 with respect to information stored therein and characteristics of the information.

The voltage supply 360 receives a voltage provided by the power voltage generator 350, and generates and provides a power voltage (VDD) necessary for the display panel 340, or provides a grounded voltage (VSS). Furthermore, the voltage supply 360 may receive a voltage of DC 24V from the power voltage generator 350 and generate a plurality of power voltages (VDD), and may select a specific power voltage (VDD) under control of the controller 310 and provide the selected power voltage to the display panel 340. To achieve this, the voltage supply 360 may further include switching elements to provide a specific voltage selected under control of the controller 310.

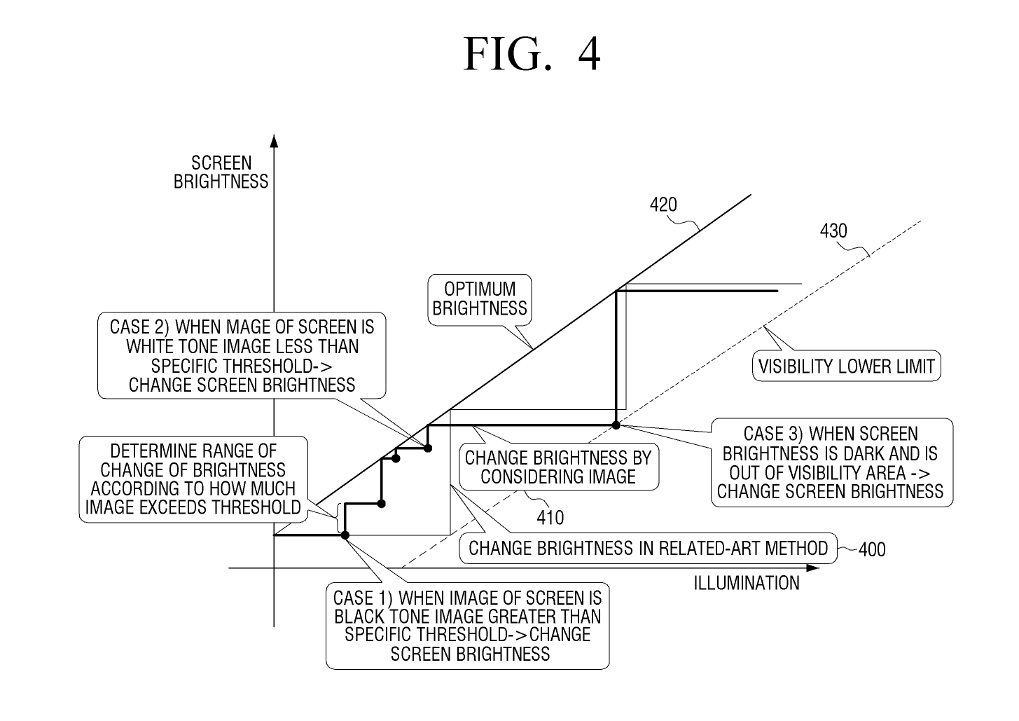

FIG. 4 is a diagram illustrating a method for setting screen brightness of an image display apparatus shown in any of FIGS. 1 to 3 in according to an embodiment of the present invention.

Referring to FIG. 4 along with FIG. 1, the image display apparatus 90 according to an embodiment has optimum screen brightness values matched with respective illumination values, as shown in 420 of FIG. 4. When a screen of the image display apparatus 90 is turned on, the image display apparatus 90 sets a screen brightness based on a brightness value corresponding to an illumination value detected at the time the screen of the image display apparatus 90 is turned on.

Thereafter, in response to determination that there is a change in a surrounding environment condition of the image display apparatus 90, the image display apparatus 90 changes the screen brightness in consideration of an illumination value at the changed location and characteristics of an image displayed on the current screen. Accordingly, the image display apparatus 90 sets the screen brightness according to line 410 to be lower than that set by considering only the illumination value at the changed location according to line 400.

As described herein above, according to an embodiment of the present invention, the image display apparatus 90 may consider changing the screen brightness in three cases. For example, as shown in FIG. 4, when the image is a white tone image and an average grayscale value of pixels of the image is greater than a threshold value, when the image is a black tone image and an average grayscale value of pixels of the image is less than a threshold value, or when screen brightness is dark and thus is out of a visibility area, that is, a visibility lower limit 430, the image display apparatus 90 may change the screen brightness. During this process, the image display apparatus 90 determines a change in the range of screen brightness value according to a degree to which the average grayscale value of the image exceeds the threshold value. For example, even when the degree is less than the threshold value, the image display apparatus 90 may set a plurality of threshold areas and may set different screen brightness for each area.

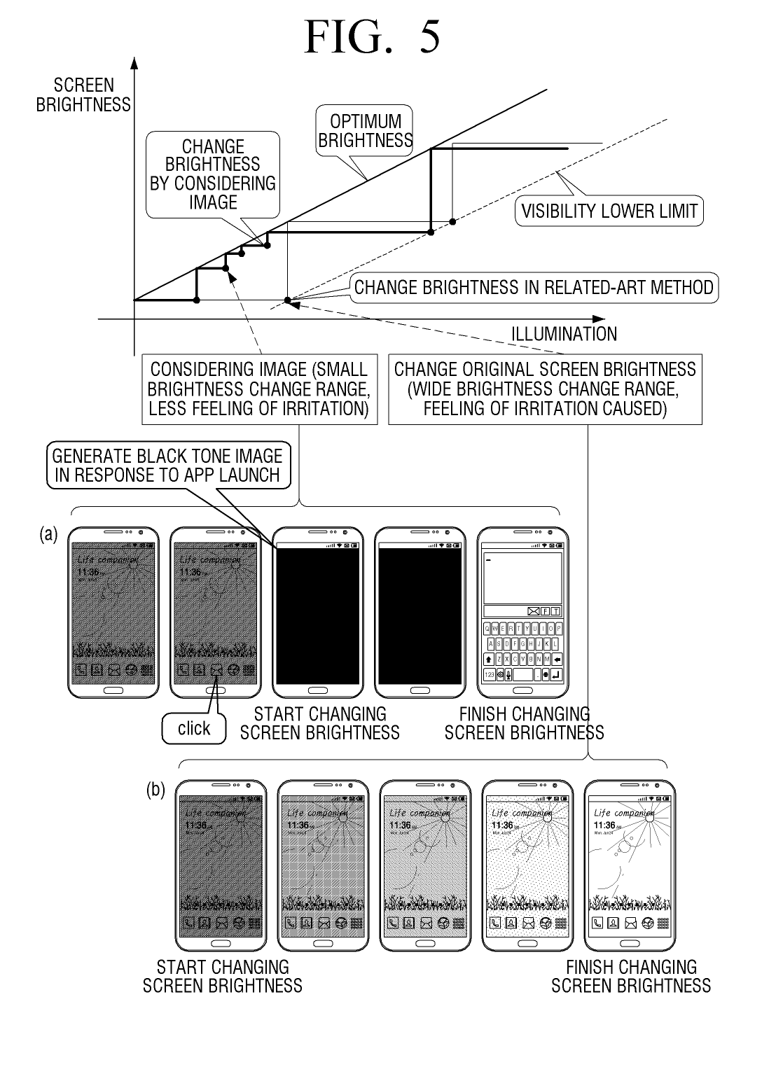

FIG. 5 is a diagram illustrating a result of a comparison between a screen display state of the image display apparatus according to an embodiment of the present invention and a screen display state of a related-art apparatus.

Referring to view (a) of FIG. 5 along with FIG. 1, according to an embodiment of the present invention, an image display apparatus 90 considers characteristics of an image in changing screen brightness, and there is minor deviation in screen brightness in relative to a deviation in screen brightness with respect to a related-art method of view (b) of FIG. 5.

Accordingly, according to an embodiment of the present invention, a brightness close to an optimum brightness can be maintained, thereby better visibility than visibility provided with respect to the related-art method, which includes a black screen.

In addition, the image display apparatus 90 according to an embodiment of the present invention changes the screen brightness in response to a determination that conditions of a surrounding environment have been changed, and may additionally consider specific situations, such as when the user drives a specific application.

To this end, the image display apparatus 90 reduces a user's discomfort relative to change the screen brightness based only upon changes of conditions of the surrounding environment.

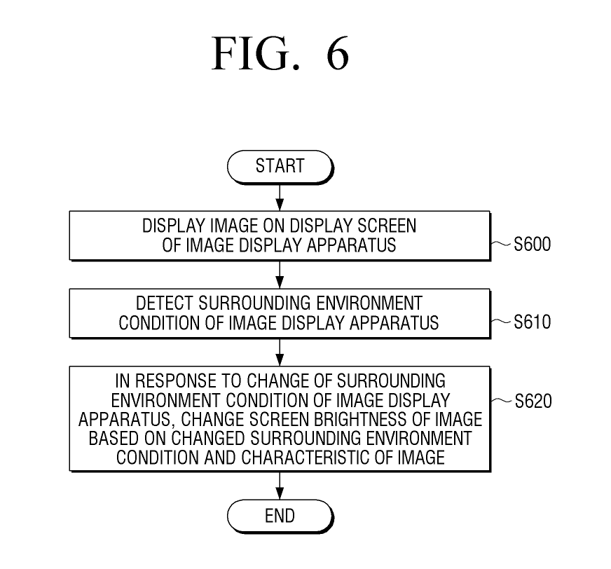

FIG. 6 is a flowchart illustrating a driving process of an image display apparatus according to an embodiment of the present invention.

Referring to FIG. 6 along with FIGS. 1 and 4, the image display apparatus 90 according to an embodiment displays an image on a display screen, in step S600. For example, in response to the screen being turned on, the image display apparatus 90 displays the image with a predetermined screen brightness according to conditions of a surrounding environment. More specifically, in response to the screen being initially turned on, the image display apparatus 90 sets the screen brightness to one of the optimum screen brightness values corresponding to line 420 in FIG. 4 and displays the image.

To achieve this, the image display apparatus 90 detects a surrounding environment condition of the image display apparatus 90, in step S610. For example, in response to the screen of the image display apparatus 90 being turned on, the image display apparatus 90 detects conditions of the surrounding environment and may detect that the conditions of the surrounding environment have changed.

As described above, in response to detecting the change in the conditions of surrounding environment of the image display apparatus 90, the image display apparatus 90 changes the screen brightness of the image based on the changed conditions of the surrounding environment and characteristics of an image currently displayed (or to be displayed) on the screen, in step S620. More specifically, the image display apparatus 90 changes the screen brightness to have a screen brightness value lower than a screen brightness corresponding to line 420 in FIG. 4, by performing the operation indicated by reference numeral 410 as shown in FIG. 4.

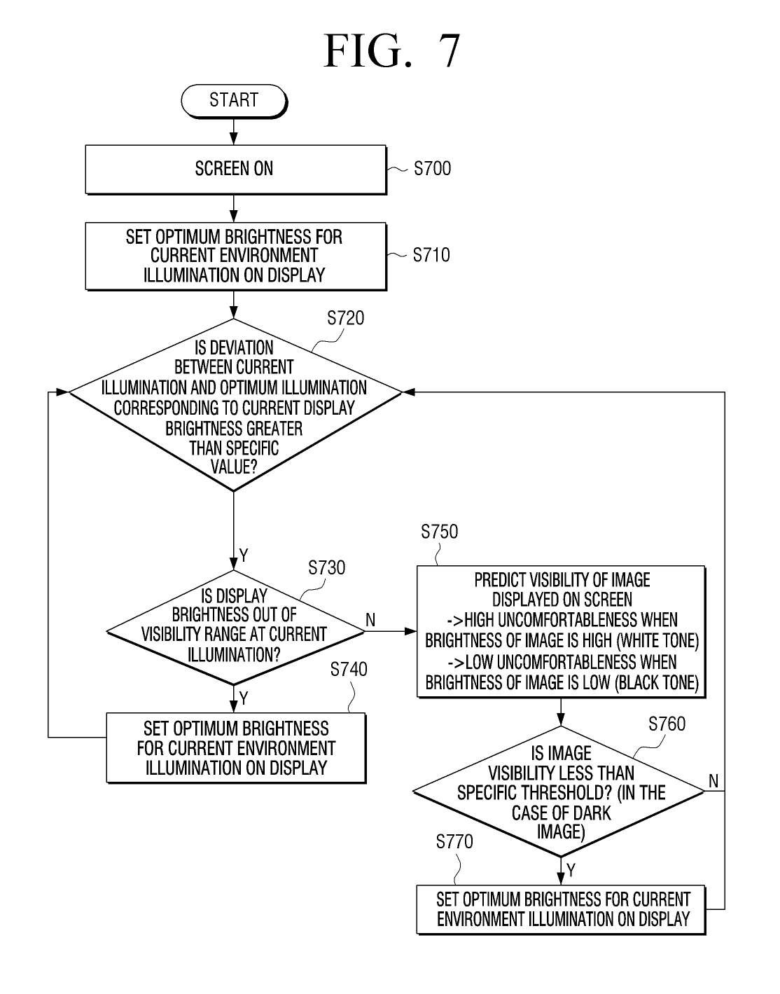

FIG. 7 is a flowchart illustrating a driving process of an image display apparatus according to another embodiment of the present invention.

Referring to FIG. 7 along with FIG. 1, according to an embodiment of the present invention, a screen of the image display apparatus 90 is turned on according to a user's request, n step S700. For example, the user's request may be made by a touch on the image display apparatus 90.

Next, the image display apparatus 90 sets a predetermined screen brightness corresponding to a current illumination (i.e., an optimum brightness), in step S710.

In this process, the image display apparatus 90 determines whether a surrounding environment condition of the image display apparatus 90 has changed, in step S720. For example, the image display apparatus 90 may determine whether a deviation between a brightness value of screen brightness corresponding to a previous illumination value and a brightness value of screen brightness corresponding to the changed illumination value is greater than a specific value, in order to determine whether the surrounding environment condition has sufficiently changed.

In response to determining that the deviation is greater than the specific value, the image display apparatus 90 further determines whether the brightness value of the screen brightness at the current illumination value is out of a visibility rang, in step S730.

For example, in response to a determination that the brightness value is outside of the visibility range, the image display apparatus 90 displays the image with an optimum screen brightness suitable for illumination of the current environment, in step S740. More specifically, the image display apparatus 90 does not consider a characteristic of the image when the illumination of the current environment is outside of the visibility range.

In response to a determination that the screen brightness falls within the visibility range in step S730, the image display apparatus 90 sets the screen brightness in consideration of an optimum screen brightness suitable for the current illumination and the characteristics of the image

To achieve this setting, the image display apparatus 90 analyzes the characteristics of the image and determines a degree of visibility, in step S750. More specifically, the image display apparatus 90 determines whether the image is a black tone image or a white tone image.

Based upon the result of the determination of whether the image is the black tone image or white tone image, the image display apparatus 90 further determines whether the degree of visibility is greater than or less than a threshold value, in step S760. For example, in response to determining that the image is the black tone image, the image display apparatus 90 determines whether the degree of visibility is less than the threshold value.

In response to a determination that the degree of visibility is less than the threshold value, the image display apparatus 90 changes the screen brightness in consideration of the characteristics of the image, in step S770.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. An image display apparatus comprising:
a display configured to display an image;
a sensor configured to detect a condition of a surrounding environment of the image display apparatus; and
a brightness adjuster configured to change, in response to detection of a change in the condition of the surrounding environment of the image display apparatus, a screen brightness of the display based on the detected changed condition of the surrounding environment.

2. The image display apparatus of claim 1, wherein the condition of the surrounding environment is ambient light, and the characteristic of the image is a degree of shade of the image.

3. The image display apparatus of claim 1, wherein the brightness adjuster is configured to change the screen brightness to have a value lower than a value of a predetermined screen brightness, in response to the changed condition of the surrounding environment.

4. The image display apparatus of claim 1, wherein the brightness adjuster is further configured to determine the characteristic of the image, and change the screen brightness in response to determining that the image is a white tone image having an average grayscale value less than a threshold value or determining that the image is a black tone image having an average grayscale value greater than the threshold value.

5. The image display apparatus of claim 1, wherein, in response to a determination that the screen brightness determined based on the changed condition of the surrounding environment and the characteristic of the image is below a predetermined lower limit for the changed condition of the surrounding environment, the brightness adjuster is configured to change the screen brightness to predetermined screen brightness matched with the predetermined lower limit.

6. The image display apparatus of claim 1, wherein the sensor comprises an illumination sensor configured to detect ambient light of the image display apparatus, and
wherein the brightness adjuster comprises:
an image analyzer configured to analyze the image and determine the characteristic of the image in response to a change of the ambient light; and
a controller configured to change the screen brightness based on the detected ambient light and the determined characteristic of the image.

7. The image display apparatus of claim 6, wherein the image analyzer is further configured to analyze pixel values for pixels of the image and determine the characteristic of the image according to the analyzed pixel values.

8. The image display apparatus of claim 6, wherein the brightness adjuster further comprises a backlight unit configured to provide light to the display, and
wherein the controller is further configured to control the backlight unit to change the screen brightness.

9. The image display apparatus of claim 6, wherein the display comprises a plurality of light emitting elements corresponding to pixels of the image, and
wherein the controller is further configured to control at least one of an amount of electric current and a voltage level of the light emitting elements to change the screen brightness.

10. The image display apparatus of claim 6, wherein the brightness adjuster further comprises a storage configured to store information regarding the predetermined screen brightness and further regarding a screen brightness lower than the predetermined screen brightness, and
wherein the storage is configured to store the information in a form of a lookup table.

11. A method of controlling an image display apparatus, the method comprising:
displaying an image on a display screen of the image display apparatus;
detecting a condition of a surrounding environment of the image display apparatus; and
changing, in response to detection of a change in the condition of the surrounding environment of the image display apparatus, a screen brightness of the image based on the detected changed condition of the surrounding environment.

12. The method of claim 11, wherein the condition of the surrounding environment condition is ambient light, and the characteristic of the image is a degree of shade of the image.

13. The method of claim 11, wherein changing the screen brightness comprises changing the screen brightness to have a value lower than a value of a predetermined screen brightness in response to the changed condition of the surrounding environment.

14. The method of claim 11, wherein changing the screen brightness comprises determining the characteristic of the image, and changing the screen brightness in response to determining that the image is a white tone image having a first average grayscale value less than a first threshold value or determining that the image is a black tone image a second average grayscale value greater than a second threshold value.

15. The method of claim 11, wherein changing the screen brightness comprises, in response to a determination that the screen brightness determined based on the changed condition of the surrounding environment and the characteristic of the image is below a predetermined lower limit for the changed condition of the surrounding environment, changing the screen brightness to predetermined screen brightness matched with the predetermined lower limit.

16. The method of claim 11, wherein detecting the surrounding environment condition comprises detecting ambient light of the image display apparatus, and
wherein changing the screen brightness comprises:
analyzing the image and determining the characteristic of the image in response to a change of the ambient light; and
changing the screen brightness based on the detected ambient light and the determined characteristic of the image.

17. The method of claim 16, wherein determining the characteristic of the image comprises analyzing pixel values for pixels of the image and determining the characteristic of the image according to the analyzed pixel values.

18. The method of claim 16, wherein changing the screen brightness further comprises providing light to the display screen, and
wherein the method further comprises controlling the light to change the screen brightness.

19. The method of claim 16, wherein the display screen to display the image comprises a plurality of light emitting elements corresponding to pixels of the image, and
wherein changing the screen brightness comprises controlling at least one of an amount of electric current and a voltage level of the light emitting elements to change the screen brightness.

20. The method of claim 16, wherein changing the screen brightness further comprises storing information regarding the predetermined screen brightness and further regarding a screen brightness lower than the predetermined screen brightness, and
wherein the information is stored in a form of a lookup table.
